(19) United States
(12) Patent Application Publication
(10) Pub. No.: US 2005/0177862 A1
(43) Pub. Date: Aug. 11, 2005

(54) Video information collection system

(76) Inventor: Han-ping Chen, Saratoga, CA (US)

Correspondence Address: Han-ping Chen, P.O. Box 2871, Saratoga, CA, 95070, US

(21) Appl. No.: 10/773,430

(22) Filed: Feb. 9, 2004

(51) Int. Cl. H04N 7/16; H04N 7/084; H04N 7/08; G06F 13/00; H04N 5/445; G06F 3/00; H04N 7/087

(52) U.S. Cl. 725/135; 725/40; 348/563; 348/473

(57) ABSTRACT

An information collection method and apparatus retrieves, stores, and interactively displays block-oriented text and image information from broadcasting television video, by analyzing the information screen images from the video source providers on selected channels, with the unilateral processing at the viewer end alone. Also, the present invention provides a method for the video source providers to supply additional information with special image patterns in selected screen areas.

### BACKGROUND OF THE INVENTION

This invention relates to video, television, and the broadcasting of real-time stock and news information.

Broadcasting, cable, and satellite television programs sometimes contain real-time stock and news information in the form of viewable texts. These texts typically appear as a formatted screen, a partial screen, or a stripe along the bottom side of the screen. Text strings in a stripe near the bottom edge may appear to be running from the right to the left.

These texts normally stay on the screen for a short period of time, allowing the viewer to read them briefly. In the case of running text strings, new items constantly enter from the right, as the old items vanishing to the left.

Financial information networks often use these methods to provide viewers with up-to-date financial indexes, interest rates, as well as real-time stock prices, volumes, and quotations.

As some notable subjects appear on the screen, viewers may find them vanishing too quickly to read or remember clearly. This is certainly a major deficiency.

Due to this limitation, viewers must pay close attention for the information to appear. If missed, viewers need to wait a while for the information to re-appear a second time. Some of these messages may not re-appear again.

As a result, broadcasters need to limit the amount of information to send on the screen. They also need to repeatedly send selected texts in a periodical fashion. In the case of stock quotations, a group of most notable issues are sent over and over in a text stripe at the bottom edge of the screen.

In the case of weather reports, weather conditions of various areas are listed briefly on the television screen. For the forecast of a certain city, viewers need to catch the exact showing spot at the precise time.

News headlines also appear regularly or irregularly on certain stations. Some of them draw the attention of the viewers, but disappear quickly before the viewers have a chance to read the entire message.

These phenomena may be the nature of real-time television broadcasting, but they remain to be a shortcoming that viewers may wish to overcome.

### BRIEF SUMMARY OF THE INVENTION

This invention provides a method and apparatus to retrieve, store, organize, and interactively display text-oriented images from real-time television broadcasting.

This invention also provides a method and apparatus to perform information collection with unilateral processing of ordinary video screen images at the viewer end alone.

This invention further provides a method for a video source provider to deliver text information with none or minimal changes to existing video broadcasting screen format.

### BRIEF DESCRIPTION OF THE DRAWINGS

FIG. 1 shows a preferred embodiment of the present invention for a video information collection system.

FIG. 2 shows an example of a video source screen for stock activities.

FIG. 3 shows another example of a video source screen for news headlines.

FIG. 4 shows a preferred embodiment of the present invention for an information collection database.

FIG. 5 shows another preferred embodiment of the present invention for an information collection database.

FIG. 6 shows a screen form to present the collected information.

FIG. 7 shows another screen form to present the collected information.

FIG. 8 shows another example of an information source screen.

FIG. 9 shows an enlarged portion of an image stripe for the video source screen.

FIG. 10 shows a preferred embodiment of the present invention for a remote control unit.

### DETAILED DESCRIPTION OF THE INVENTION

The present invention will be illustrated with some preferred embodiments.

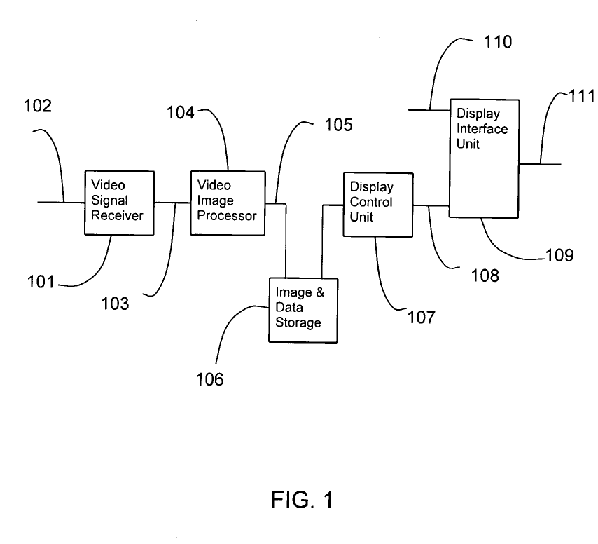

FIG. 1 shows a preferred embodiment of the present invention for a video information collection system.

The video signal receiver 101 receives broadcasting video signal 102 from a video media source. Video media sources include broadcasting, cable, and satellite television networks.

At the video media sources, a number of composite signals for individual channels are multiplexed into a modulated broadcasting signal for transmission.

The video signal receiver 101 includes a channel tuner to select a video source channel and transform it to a composite video signal 103.

The composite video signal 103 is typically based on the NTSC standard in the US, or a choice of the NTSC, PAL or SECAM standards in other countries.

A video image processor unit 104 retrieves video images and information data 105 from the composite video signal 103 and store into the video image and data storage 106. The video image processor unit 104 may store the bitmap image of the full screen, partial screen, or selected screen areas. To conserve storage capacity, it may also store the target bitmap in simplified, modified, or compressed forms.

The video image processor unit 104 retrieves screen images upon certain pre-determined selection criteria. A set of selection parameters determines the television channels, the retrieval timeslots, the retrieval frequencies, the locations of screen image areas, and the image characteristics.

The video image processor unit 104 may compare selected areas of two consecutive screens for significant changes and stores only the distinctive image patterns.

In addition, the video image processor unit 104 may perform certain image processing or character recognition operations to transform selected parts of the source video screen image into numeric or alphabetic characters. These characters are easier to store.

A display control unit 107 controls the display of the collected images and data and generates a video display signal 108.

If the video display signal 108 is generated from previously stored images and data, the video display interface unit 109 may optionally overlays the video display signal 108 onto the current real-time video signal 110 to generate the output video signal 111. The current real-time video signal 110 may be a regular television program that the viewer is currently viewing, or a pre-recorded program that the viewer is currently playing back.

The real-time video signal 110 may be the video image 103 from the video signal receiver 101, currently tuned to a channel for viewing. It may also be from another internal or external video signal receiver.

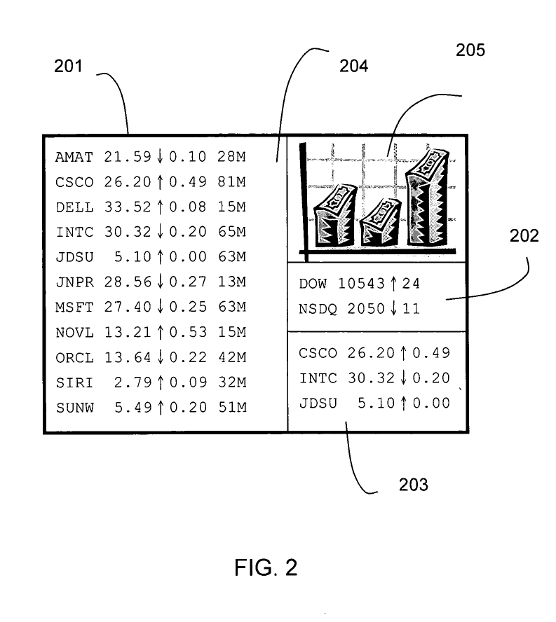

FIG. 2 shows an example of a video source screen for stock activities of a financial service television channel. In screen 201, area 202 shows major stock indexes. It may cycle through major US and international indexes. Area 203 lists the current volume leaders. It includes the stock prices and variation directions of the most-traded issues.

Area 204 is a partial list of the stock prices, variation directions, and trading volumes. It may cycle through a set of selected issues over a period of time. It may also include other information such as selling, biting, daily high, and daily low prices.

Area 205 shows a statistical chart. Graphics elements are likely to occupy more memory spaces. To conserve data storage, these elements may not be included as a part of the essential database elements.

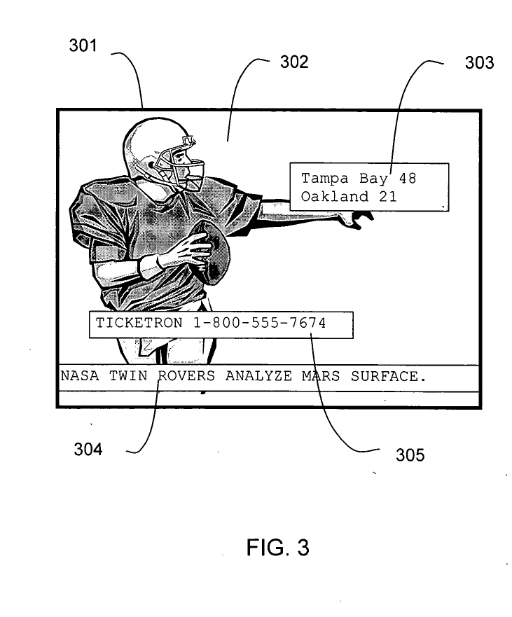

FIG. 3 is a diagram of a video source screen for news headlines. Assume that the television screen 301 is currently showing a sport event 302. Area 303 shows the current scores. It may also show scores of other related sport events in other cities.

Area 304 is a stripe of real-time news headlines. These headlines are shown to keep the viewers informed of other news while staying tuned with the current channel.

Area 305 is a telephone number that pops up during the regular program to show a phone number for ticket information of coming events.

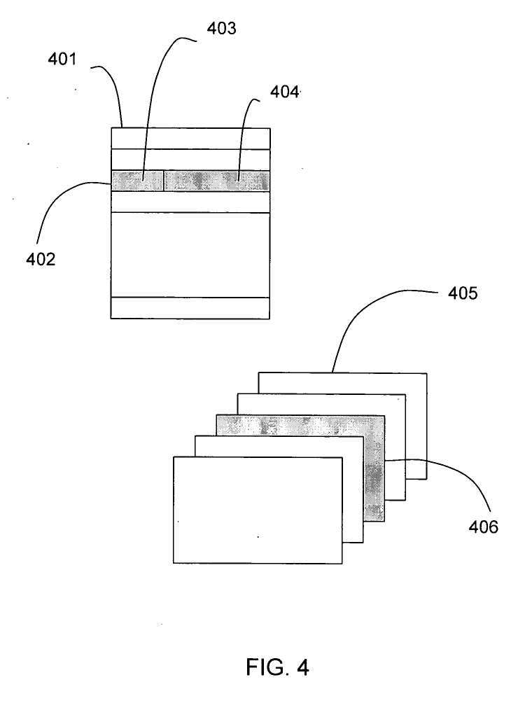

FIG. 4 shows a preferred embodiment of the present invention for an information collection database. In this preferred embodiment, the information collection data are stored in a full or partial screen bitmap format.

The information collection database includes a screen index table 401, which lists a number of stored screens. Each screen index table entry 402 contains a screen pointer 403, pointing to the memory location for the full or partial screen bitmap.

In case that the full or partial screens are stored in simplified or compressed form, the screen table entry 402 may also contain a bitmap parameter field 404 to describe the bitmap memory size or other formatting parameters.

The screen pointer 403 points to a screen image buffer area 406 within a screen image data structure 405.

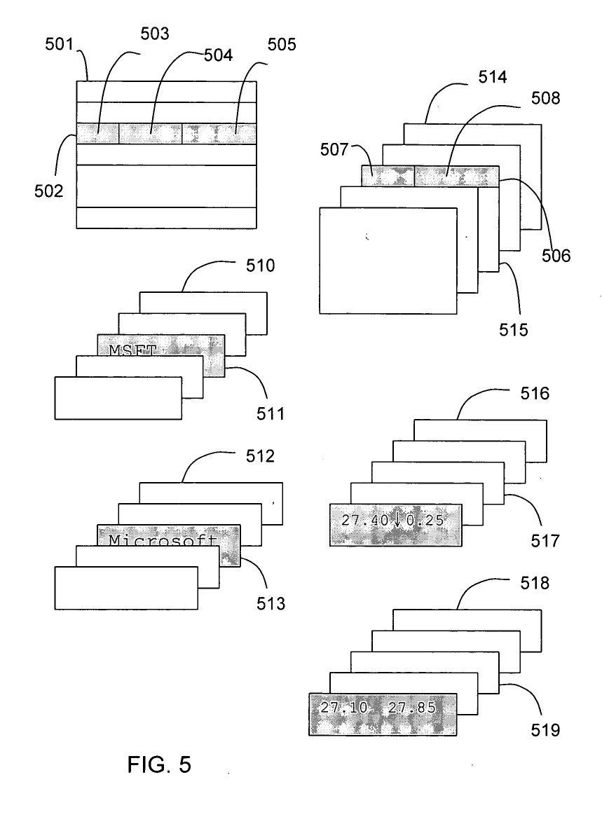

FIG. 5 shows another preferred embodiment of the present invention for an information collection database. In this preferred embodiment, the image screens are divided into functional blocks.

In the case of stock information, the contents of the functional blocks are as described in FIG. 2. The present invention may perform image processing or character recognition operations to transform some of these image blocks into numeric or alphabetic characters.

The information database includes an index table 501, which lists a number of stock issues. Each index entry 502 contains a stock sticker field 503. The stock sticker field 503 may be an image pointer to a stock sticker image block 511 in the stock sticker image structure 510. It may also be an explicit alphabetic or numeric code previously transformed from the stock sticker image block.

An index entry 502 may also contain a company name field 504. The company name field 504 may be an image pointer to a company name image block 513 in the company name image structure 512. It may also be an explicit company name text string previously transformed from the company name image block.

An index entry 502 may also contain a stock activity data pointer 505 to point to a stock activity data sub-table entry 515 in a stock activity data sub-table structure 514. The stock activity data sub-table entry 515 contains a list of stock activity entries by categories. A stock activity entry 506 may contain a stock price field 507 and a daily statistics field 508. It may contain other fields such as trading volumes and company profiles.

The stock price field 507 may be an image pointer to a stock price image block 517 in a stock price image structure 516. It may also be a numeric or text string previously transformed from the stock price image block.

The daily statistics field 508 may be an image pointer to a daily statistics image block 519 in a daily statistics image structure 518. It may also be a numeric or text string previously transformed from the daily statistics image block.

The output stock information screen to be displayed on the video or television screen may take a number of forms. The first stock information screen form resembles the original stock information source screen image, as shown in FIG. 2. It shows the stock sticker names, stock prices, and variation directions, along with stock indexes and other trading activities.

This time, however, the stock information screens are shown in a more responsive fashion, immediately and interactively according to the user commands.

The first stock information screen form may be generated directly from the stored full or partial screen without major formatting and alteration. It may also be assembled from a combination of the divided image blocks or the transformed alphanumeric characters.

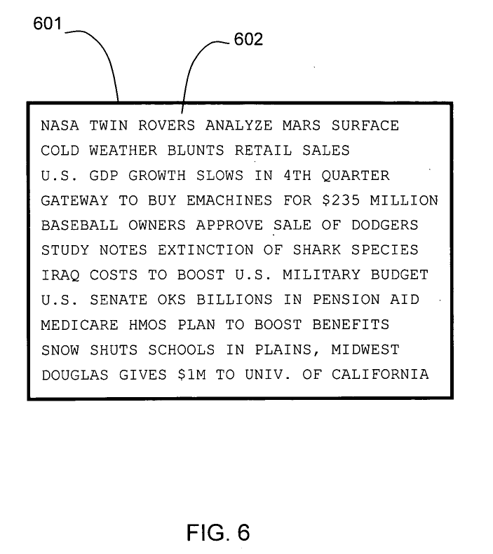

FIG. 6 shows a screen form to present the collected information. Screen 601 lists the news headlines collected previously.

Since it is in a form different from the original information screen, it needs to be assembled from a combination of the divided image blocks or the extracted alphanumeric characters.

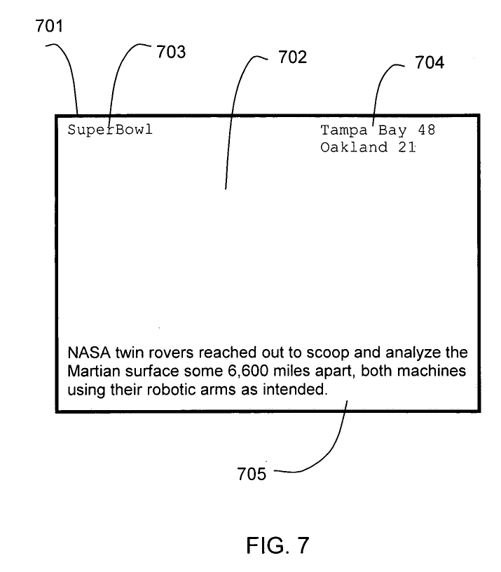

FIG. 7 shows another screen form to present collected information. In screen 701, the center portion 702 shows the current real-time video of the regular program, assuming to be the same sport event in this case. Information data are shown as screen overlays.

Area 703 shows a title description of the current event, which may not be a part of the current broadcasting video screen, but a stored image from the information collection database. Area 704 shows the current score, which again may not on the current broadcasting video screen, but also a stored image from the information collection database.

Area 705 shows a news segment, from stored images in the information collection database. It is selected to display by the viewer, while staying tuned to the current channel.

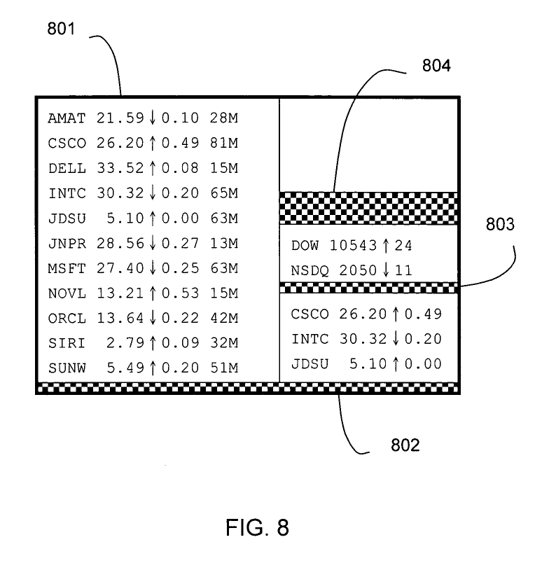

FIG. 8 shows another example of an information source screen from the video source provider. In addition to the normal character display 801, it contains special image stripes 802, 803, and 804 at selected locations. These locations are shown as patterned areas.

Image stripe 802 is located near the bottom of the screen. Image stripe 803 is located below the stock indexes. Image stripes 803 are located in the lower part of the statistical chart.

These special image stripes contain special patterns that are functionally similar to a bar code, except in two dimensions. With these image stripes, a source image screen can carry additional information to deliver to the viewers.

For viewers without the proper receivers, these special patterns simply look like patterned color boundaries.

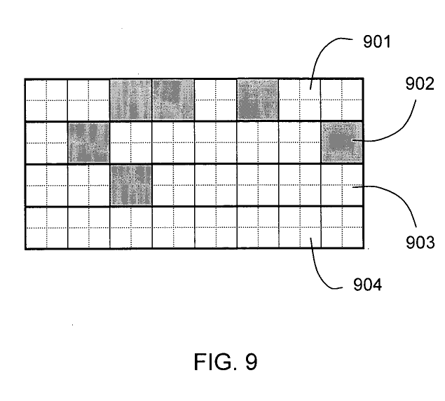

FIG. 9 shows an enlarged portion of a special image stripe for the video source screen in FIG. 8. To ensure the accurate delivery of the special image patterns from the video providers to the end viewers, the minimum resolution unit of the image pattern is defined to be a number of lines by a number of pixels. In FIG. 9, it is shown as a 2-by-2 block.

In FIG. 9, this portion of the image stripe contains four ASCII character codes, shown one character code on top of another. They may be viewed as the first characters of four horizontal pattern rows. Segment 901 contains the code 0011,0100, the ASCII code for the number “4”. Segment 902 contains the code 0100,0001, the code for the letter “A”. Segment 903 contains the code 0010,0000 for a space symbol. Segment 904 contains a null code 0000,0000, which may be used as an end of string mark.

To accommodate the special image pattern stripes, the video image processor unit, such as unit 104 in FIG. 1, needs to perform image-processing functions to transform these image patterns into character codes at the viewer end.

The source provider must generate these patterns when preparing the video source screen.

However, the generation of these patterns only requires software changes or data changes. It does not require hardware changes in the video source provider equipment.

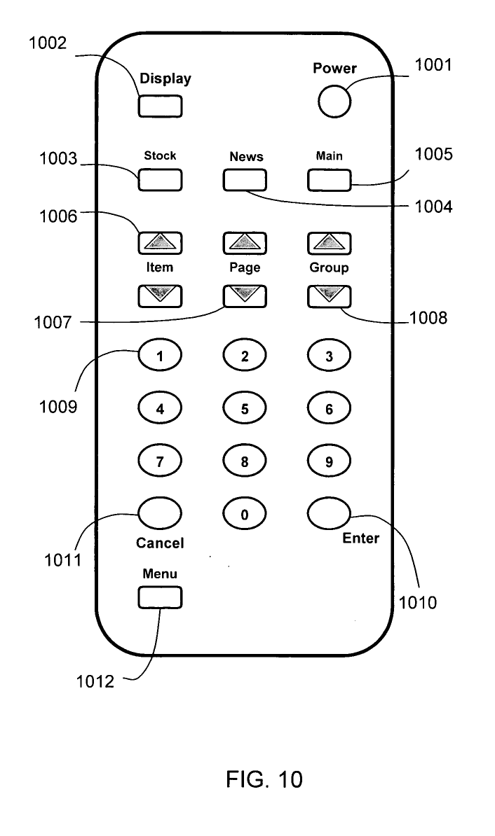

FIG. 10 shows a preferred embodiment of the present invention for a remote control unit for the user to control the basic operations of the information collection system.

Power button 1001 controls the power on and off. Button 1002 turns on and off of the information display. Special functional buttons 1003, 1004, and 1005 selects the information categories. Button 1003 selects the information category for stock activities. Button 1004 selects the information category for news headlines. Button 1005 selects the main category selection display for the viewer to select other sub-categories.

Button pair 1006 moves the selected item up or down. Button pair 1007 moves a display page up or down. Button pair 1008 changes the display group selection.

The array of numerical buttons 1009 provides numerical entries for quick selection of items, pages, groups, or categories. Button 1010 is the entry button. Button 1011 is the cancel button. Button 1012 controls the menu operation to change system settings.

1. An information collection system comprising:
(a) a primary analog video signal input line;
(b) a primary analog video signal interface unit;
(c) a screen image processing unit;
(d) an information data storage unit;
(e) an information display unit;
wherein said primary analog video signal interface unit receives a primary video signal from said primary analog video signal input line and sends to said screen image processing unit;
wherein said primary video signal contains a plurality of source screen images which contain number entries as numeric font image blocks, text entries as alphanumeric font image blocks, or image entries as bitmap image blocks;
wherein said screen image processing unit retrieves and selectively stores a number of said source screen images into said information data storage unit;
wherein said information display unit uses said source screen images to generate an output video display signal.

2. The information collection system of claim 1, wherein said primary video signal is from a local or remote video source, such as cable, broadcast, satellite, VCR, VCD, DVD, or other video producing or recording devices.

3. The information collection system of claim 1,
wherein said screen image processing unit stores said source screen images in full screen form, partial screen form, or selected screen image blocks;
wherein said screen image processing unit stores said source screen images or image blocks in full bitmap, simplified, modified, or compressed forms.

4. The information collection system of claim 1, wherein said screen image processing unit selects the source screen images or image blocks to store according to a set of selection criteria, which include broadcasting channels, broadcasting timeslots, screen locations of image blocks, or special image characteristics.

5. The information collection system of claim 1, wherein said screen image processing unit analyzes said source screen images to determine whether there is a significant content change in selected image areas and only stores the distinguishable revisions of screen image contents.

6. The information collection system of claim 1 wherein said screen image processing unit further performs image-processing or character-recognition operations to transform selected parts of said source screen images into numeric or alphabetic characters.

7. The information collection system of claim 1 wherein said video display unit further overlays said source screen images onto a secondary analog or digital video signal to generate the output video display signal.

8. An information collection system comprising:
(a) a primary analog video signal input line;
(b) a primary analog video signal interface unit;
(c) a screen image processing unit;
(d) an information data storage unit;
(e) an information display unit;
wherein said primary analog video signal interface unit receives a primary video signal from said primary analog video signal input line and sends to said screen image processing unit;
wherein said primary video signal contains a plurality of source screen images which contain number entries as numeric font image blocks, text entries as alphanumeric font image blocks, or image entries as bitmap image blocks;
wherein said screen image processing unit analyzes said source screen images to retrieve the information data and stores into said information data storage unit;
wherein said screen image processing unit performs image-processing or character-recognition operations to transform selected parts of said source screen images into numeric or alphabetic characters;
wherein said information display unit uses the information data to generate an output video display signal.

9. The information collection system of claim 8, wherein said primary video signal is from a local or remote video source, such as cable, broadcast, satellite, VCR, VCD, DVD, or other video producing or recording devices.

10. The information collection system of claim 8,
wherein said screen image processing unit stores the information data in characters, full screen images, partial screen images, or selected screen image blocks;
wherein said screen image processing unit stores the source screen images or image blocks in full bitmap, simplified, modified, or compressed forms.

11. The information collection system of claim 8, wherein said screen image processing unit selects the source screen images or image blocks to store according to a set of selection criteria, which include broadcasting channels, broadcasting timeslots, screen locations of image blocks, or special image characteristics.

12. The information collection system of claim 8 wherein said video display unit further overlays the information data onto a secondary analog or digital video signal to generate the output video display signal.

13. An information collection system comprising:
(a) a primary analog video signal input line;
(b) a primary analog video signal interface unit;
(c) a screen image processing unit;
(d) an information data storage unit;
(e) an information display unit;
wherein said primary analog video signal interface unit receives a primary video signal from said primary analog video signal input line and sends to said screen image processing unit;
wherein said primary video signal contains a plurality of source screen images which contain number entries as numeric font image blocks, text entries as alphanumeric font image blocks, or image entries as bitmap image blocks;
wherein one or more of said screen images contain a plurality of special bitmap image patterns in selected screen areas;
wherein said screen image processing unit analyzes said special bitmap image patterns to extract coded information;
wherein said screen image processing unit stores said source screen images, image blocks, or coded information into said information data storage unit;
wherein said information display unit uses said source screen images, image blocks, or coded information to generate an output video display signal.

14. The information collection system of claim 13, wherein said primary video signal is from a local or remote video source, such as cable, broadcast, satellite, VCR, VCD, DVD, or other video producing or recording devices.

15. The information collection system of claim 13,
wherein said screen image processing unit stores said source screen images in full screen images, partial screen images, or selected screen image blocks;
wherein said screen image processing unit stores the source screen images or image blocks in full bitmap, simplified, modified, or compressed forms.

16. The information collection system of claim 13, wherein said screen image processing unit selects the source screen images or image blocks to store according to a set of selection criteria, which include broadcasting channels, broadcasting timeslots, screen locations of image blocks, or special image characteristics.

17. The information collection system of claim 13 wherein said screen image processing unit further performs image-processing or character-recognition operations to transform selected parts of source screen images into numeric or alphabetic characters.

18. The information collection system of claim 13 wherein said video display unit further overlays said source screen images, image blocks, or coded information onto a secondary analog or digital video signal to generate the output video display signal.
